(19) United States
(12) Patent Application Publication
(10) Pub. No.: US 2014/0079517 A1
(43) Pub. Date: Mar. 20, 2014

(54) LIFT GATE SYSTEM WITH EXTENSION PLATE AND A LIFT GATE PLATFORM

(71) Applicant: Karapet Ablabutyan, Glendale, CA (US)

(72) Inventor: Karapet Ablabutyan, Glendale, CA (US)

(73) Assignee: MAXON INDUSTRIES, INC., dba Maxon Lift Corp., Santa Fe Springs, CA (US)

(21) Appl. No.: 13/878,260

(22) PCT Filed: Oct. 11, 2012
(86) PCT No.: PCT/US12/59764

§ 371 Date: Apr. 8, 2013

Related U.S. Application Data
(60) Provisional application No. 61/546,006, filed on Oct. 11, 2011.

(51) Int. Cl. B60P 1/44

(52) U.S. Cl. CPC B60P 1/4414; B60P 1/445
USPC 414/546; 414/812

(57) ABSTRACT

The present invention provides a lift gate system. In one embodiment, the lift gate system comprises a lift platform, a lifting mechanism, and at least one stop member. The lifting mechanism moves the lift platform between a raised position and a lowered position. The lift platform is substantially aligned with an extension plate when the lift platform is in the raised position. The stop members are positioned between the extension plate and the lift platform. The stop members provide a gap between the extension plate and the lift platform when the lift platform is in the raised position.

### CROSS REFERENCE TO RELATED APPLICATIONS

This application claims the priority benefit of U.S. Provisional Patent Application Ser. No. 61/546,006 filed Oct. 11, 2011, incorporated herein by reference in its entirety.

### BACKGROUND OF THE INVENTION

1. Field of the Invention

The present invention relates generally to lift gates, and in particular, to a lift gate system with a lift gate platform and an extension plate.

2. Description of Related Art

Lifts such as lift gates are typically mounted at a structure such as an opening at the rear of a vehicle to lift payloads on a lift platform from one level (e.g., ground level) up to another level (e.g., the bed of the vehicle), or vice versa.

One type of lift gate employs parallelogram linkages to maintain a lift platform in a horizontal plane through the lifting range. The lift platform is attached to the linkages by pivot members, which allow the lift platform to be pivoted. Operation of the lifting mechanism may also rotate the lift platform into an inverted, stowed position beneath the vehicle body. Actuators, such as hydraulic actuators and electric actuators, are used to provide lifting force for moving the lift platform.

### BRIEF SUMMARY OF THE INVENTION

The present invention provides a lift gate system. In one embodiment, the lift gate system comprises a lift platform, a lifting mechanism, and one or more stop members. The lifting mechanism moves the lift platform between a raised position and a lowered position. The lift platform is substantially aligned with an extension plate of a vehicle when the lift platform is in the raised position. Each stop member is positioned between the extension plate and the lift platform. The stop members provide a gap between an edge of the extension plate and an edge of the lift platform when the lift platform is in the raised position.

In another embodiment, at least one stop member is positioned between an extension plate and a lift platform of a lift gate. The stop members provide a gap between the extension plate and the lift platform when the lift platform is in a raised position. The lift platform is substantially aligned with the extension plate when the lift platform is in the raised position.

In yet another embodiment, a gap is provided between an extension plate and a lift platform of a lift gate when the lift platform is in a raised position. At least one stop member is positioned in the gap. Each stop member is positioned between the lift platform and the extension plate when the lift platform is in the raised position. The lift gate is pushed forward until each one stop member is directly adjacent to both the extension plate and the lift platform. The lift platform is substantially aligned with the extension plate when the lift platform is in the raised position.

These and other features, aspects and advantages of the present invention will become understood with reference to the following description, appended claims and accompanying figures.

### BRIEF DESCRIPTION OF THE DRAWINGS

FIG. 1A illustrates a top perspective view of a lift gate, wherein the lift gate platform is in a raised position, in accordance with an embodiment'of the invention.

FIG. 1B illustrates a side perspective view of a lift gate, wherein the lift gate platform is in a lowered position, in accordance with an embodiment of the invention.

FIG. 2 illustrates a side perspective view of a lift gate, in accordance with an embodiment of the invention.

FIG. 3 illustrates a side perspective view of an extension plate, in accordance with an embodiment of the invention.

FIG. 4 illustrates a cross-sectional view of a lift gate, in accordance with an embodiment of the invention.

FIG. 5 illustrates an example shackle member of a lift gate, in accordance with an embodiment of the invention.

FIG. 6 illustrates a lift gate in the stowed position, in accordance with an embodiment of the invention.

FIG. 7 illustrates a cross-sectional view of a lift gate, wherein lift platform support brackets of the lift gate are extended, in accordance with an embodiment of the invention.

FIG. 8 illustrates a lift gate in the stowed position, wherein the lift gate is stowed further back from a proximal edge of an extension plate under the vehicle bed than the lift gate in FIG. 6, in accordance with an embodiment of the invention.

### DETAILED DESCRIPTION OF THE INVENTION

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

The present invention provides a lift gate system. In one embodiment, the lift gate system comprises a lift platform, a lifting mechanism, and one or more stop members. The lifting mechanism moves the lift platform between a raised position and a lowered position. The lift platform is substantially aligned with an extension plate of a vehicle (e.g., an extension plate mounted at the bed of a truck opening) when the lift platform is in the raised position. Each stop member is positioned between the extension plate and the lift platform. The stop members provide a gap between an edge of the extension plate and an edge of the lift platform when the lift platform is in the raised position.

In another embodiment, at least one stop member is positioned between an extension plate and a lift platform of a lift gate. The stop members provide a gap between the extension plate and the lift platform when the lift platform is in a raised position. The lift platform is substantially aligned with the extension plate when the lift platform is in the raised position.

The extension plate is coupled to a rear opening of a vehicle. In one embodiment, each stop member is directly adjacent to a proximal edge of the extension plate. In another embodiment, each stop member is directly adjacent to a proximal edge of the lift platform. Each stop member prevents direct impact between the extension plate and the lift platform when the lift platform is raised to the raised position.

Each stop member restricts upward movement of the lift platform when the lift platform is in the raised position, thereby maintaining the lift platform in substantial alignment with the extension plate.

Each opposing end of the extension plate includes a protrusion member. Each protrusion member extends beyond a proximal edge of the extension plate, such that said protrusion member protects the lift gate system against impact.

At least one shackle member interconnects the lift platform with the lifting mechanism. The proximal edge of the extension plate extends beyond each shackle member.

The lifting mechanism comprises at least one hydraulic pump for moving the lift platform, a first pair of parallelogram linkages for supporting the lift platform, a second pair of parallelogram linkages for supporting the lift platform, and at least one pivot point on which a distal end of the lift platform is pivotably mounted for rotation.

In yet another embodiment, a gap is provided between an extension plate and a lift platform of a lift gate when the lift platform is in a raised position. At least one stop member is positioned in the gap. Each stop member is positioned between the lift platform and the extension plate when the lift platform is in the raised position. The lift gate is pushed forward until each one stop member is directly adjacent to both the extension plate and the lift platform. The lift platform is substantially aligned with the extension plate when the lift platform is in the raised position.

Each support bracket has a length. Providing the gap between the extension plate and the lift platform when the lift platform is in the raised position comprises extending the length of each support bracket. Pushing forward the lift gate until each stop member is directly adjacent to both the extension plate and the lift platform comprises pushing forward the lift gate towards the front of the vehicle. The lift gate is stowed further back in relation to the extension plate when the lift gate is pushed forward towards the front of the vehicle.

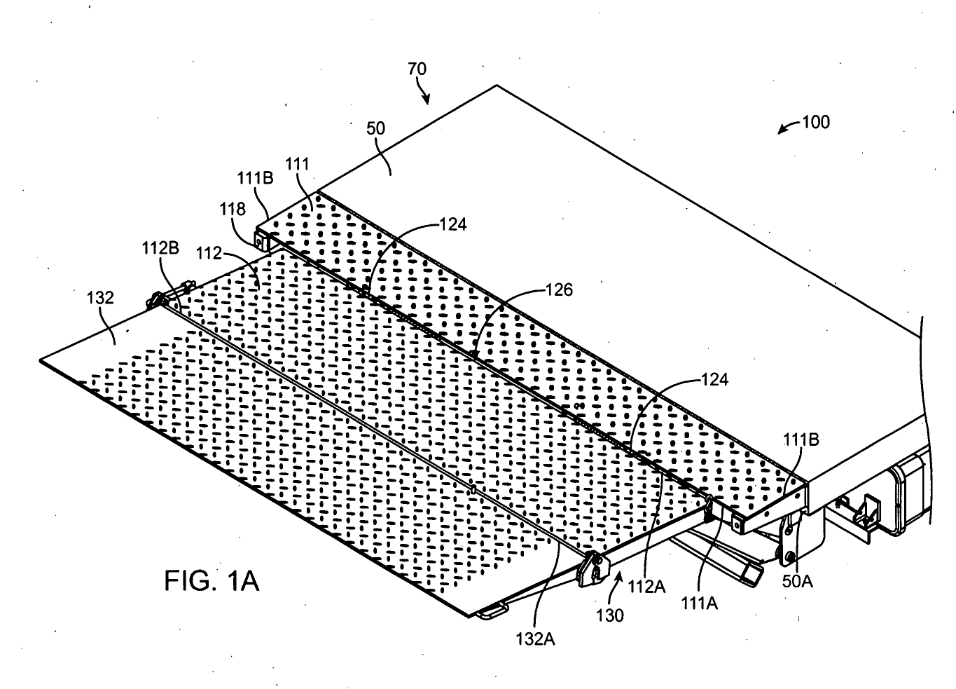

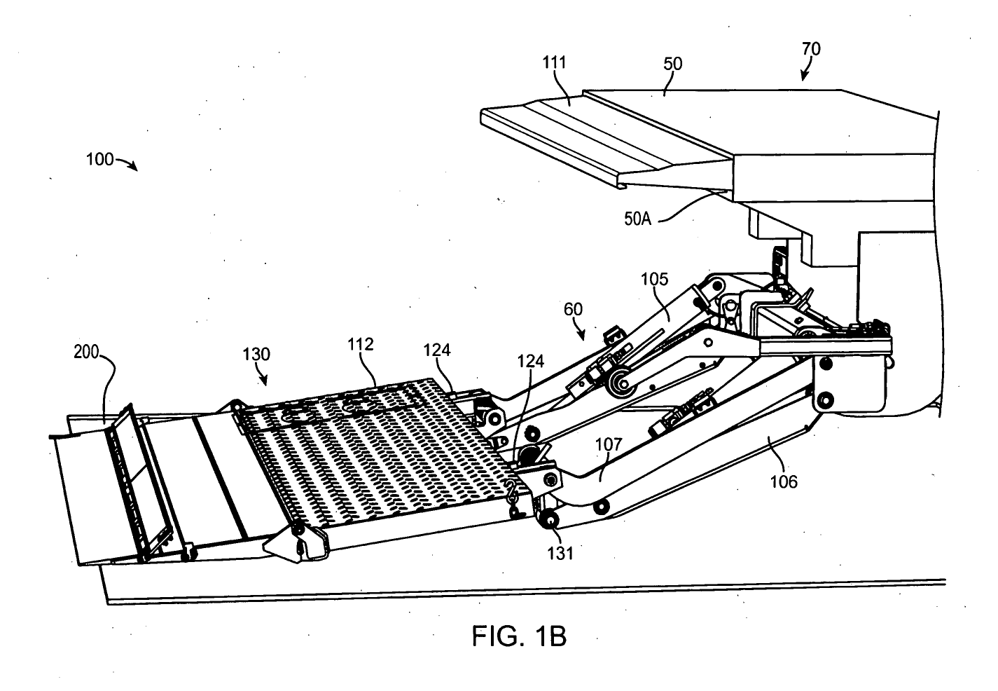

FIG. 1A illustrates a top perspective view of a lift gate system 100, in accordance with an embodiment of the invention, mounted on a vehicle opening with an extension plate 111, wherein a lifting platform 130 of the lift gate 100 is shown in a raised position in relation to the extension plate 111. The lift gate 100 is configured for mounting at a structure such as a rear frame of a vehicle (e.g., a truck). For example, the lift gate 100 may be attached to a rear opening 50A of a vehicle bed 50 of a vehicle 70, having said extension plate 111. The extension plate 111 may be coupled (e.g., welded, or removably bolted with screws or nuts and bolts) adjacent to the rear opening 50A of the vehicle bed 50 for extending the depth (reach) of the vehicle bed 50 beyond the rear opening 50A.

The load-carrying surfaces of the lift gate 100 comprise said lift platform 130 which in one embodiment includes a platform section 112 and a foldable section (“flipover”) 132. The platform section 112 has a first edge 112A and a second edge 112B that is distal to the first edge 112A. A first edge 132A of the flipover 132 is pivotally coupled to the second edge 112B of the platform section 112. The lift platform 130 is used to lift payloads from one level (e.g., ground level 200 in FIG. 1B) up to another level (e.g., the vehicle bed 50 of the vehicle 70), or vice versa.

Embodiments of the invention are useful in different types of lift gate systems. In one embodiment described herein, the lift gate 100 is a stow away lift gate. The lift gate 100 further comprises a lifting mechanism 60 (FIG. 1B) for raising, lowering, and stowing the lift gate 100. The flipover 132 is folded onto the platform section 112 during stowing of the lift gate 100.

In FIG. 1A, the lift platform 130 is shown in the raised position, wherein the platform section 112 is substantially aligned with the extension plate 111. As shown in FIG. 1A, due to the action of one or more stop members 124, the first edge 112A of the platform section 112 is not in direct contact (i.e., not flush) with the first edge 111A of the extension plate 111. As such, there is a gap (i.e., spacing) 126 between the first edge 112A of the platform section 112 and the first edge 111A of the extension plate 111 when the platform section 112 is in the raised position.

In one embodiment, said one or more stop members 124 provide said gap 126 between the first edge 112A of the platform section 112 and the first edge 111A of the extension plate 111 when the platform section 112 is in the raised position. In relation to the stop members 124, the first edge 112A and the second edge 112B of the platform section 112 are the proximal edge 112A and the distal edge 112B of the platform section 112, respectively. In relation to the stop members 124, the first edge 111A of the extension plate 111 is the proximal edge 111A of the extension plate 111. The proximal edge 112A of the platform section 112 and the proximal edge 111A of the extension plate 111 are proximate to the stop members 124.

As described in detail later herein, the stop members 124 act as a buffer between the extension plate 111 and the platform section 112. The stop members 124 prevent direct impact between corresponding edges of the extension plate 111 and the platform section 112 when the platform section 112 is rotated to the raised position to be aligned with the extension plate 111.

FIG. 1B illustrates a side perspective view of the lift gate 100, wherein the lift gate 100 is in a lowered position, in accordance with an embodiment of the invention. As shown in FIG. 1B, the lift platform 130 is in a lowered position. In one embodiment, the lift platform 130 rests against a ground level 200 when the lift platform 130 is in the lowered position.

In one embodiment, the lifting mechanism 60 of the lift gate 100 is a hydraulic system with linkages. For example, the lifting mechanism 60 comprises a pair of hydraulic cylinders 105, a first pair of parallelogram linkage arms 106, and a second pair of parallelogram linkage arms 107. The pair of hydraulic cylinders 105 actuates the raising, lowering, and stowing of the lift gate 100. The linkages 106 and 107 support the lift platform 130 as the lift gate 100 is raised, lowered, or stowed. The linkages 106 and 107 maintain the lift platform 130 in a substantially horizontal plane relative to the ground level .200 as the lift platform 130 is raised/lowered. The platform section 111 follows an arc when travelling between the lowered position (FIG. 1B) and the raised position (FIG. 1A), due to action of the parallelogram lifting mechanism.

The platform section 112 is pivotably mounted for rotation on at least one pivot point 131. During stowing of the lift gate 100, the linkages 106 and 107 and the hydraulic cylinders 105 rotate the lift platform 130 about at least one pivot point 131.

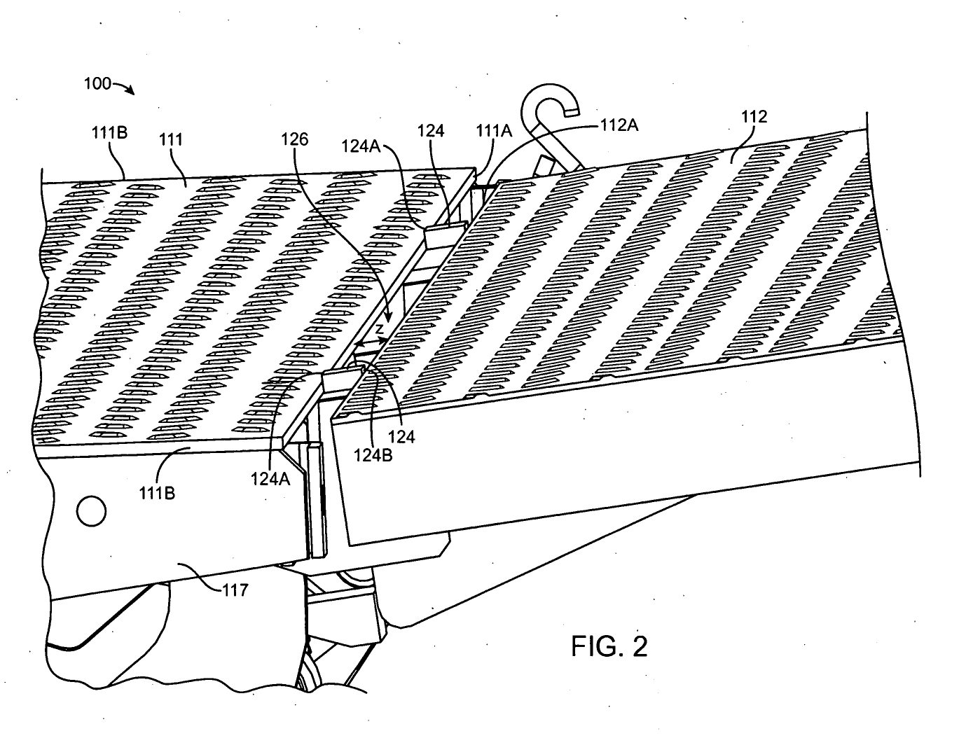

FIG. 2 illustrates a side perspective view of the lift gate 100, in accordance with an embodiment of the invention. The shape of the stop members 124 may vary. In one embodiment, the stop members 124 are substantially block shaped. For example, each stop member 124 has a width that is approximately 0.63 inches (about 1.60 centimeters), a height that is approximately 0.375 inches (about 0.95 centimeters), and a length that is approximately 1.5 inches (about 3.81 centimeters). The present invention is not limited to a stop member 124 with the example width, height, and length provided.

Each stop member 124 has a first side 124A and a second side 124B that is opposite of the first side 124A. The stop members 124 are positioned directly between the platform section 112 and the extension plate 111. Specifically, the proximal edge 111A of the extension plate 111 is in direct contact with the first side 124A of each stop member 124. As shown in FIG. 2, there is no gap (i.e., no spacing) between the first side 124A of each stop member 124 and the proximal edge 111A of the extension plate 111.

Each stop member 124 is essentially sandwiched between edges 111A and 112A when the platform section 112 is in the fully raised position, as shown in FIG. 2. The stop members 124 prevent direct impact between corresponding edges of the extension plate 111 and the platform section 112 when the platform section 112 is rotated to the raised position to be aligned with the extension plate 111. In the raised position of the platform section 112, one or more edges 111A and 112A may exert a force on the stop members 124 due to the action of the lifting mechanism 60.

Also shown in FIG. 2, the proximal edge 112A of the platform section 112 is in direct contact with the second side 124B of each stop member 124. There is no gap between the second side 124B of each stop member 124 and the proximal edge 112A of the platform section 112.

In one embodiment, the stop members 124 are integral with the platform section 112. For example, the stop members 124 may be welded directly adjacent to the proximal edge 112A of the platform section 112. In another embodiment, the stop members 124 are integral with the extension plate 111. For example, the stop members 124 may be attached directly adjacent to the proximal edge 111A of the extension plate 111.

The stop members 124 provide the gap 126 between the proximal edge 112A of the platform section 112 and the proximal edge 111A of the extension plate 111 when the platform section 112 is in the raised position. In one embodiment, the gap 126 has a width z between 0.50 inches (about 1.27 centimeters) and 0.63 inches (about 1.60 centimeters). The example numerical range provided for the width z of the gap 126 is an approximate numerical range only, and the present invention is not limited to gaps with a width within this numerical range.

Without the stop members 124, the entire proximal edge 112A of the platform section 112 impacts against the proximal edge 111A of the extension plate 111 when the platform section 112 is raised from the lowered position to the raised position. The direct impact between the extension plate 111 and the platform section 112 may cause the extension plate 111 and/or the platform section 112 to buckle and be damaged.

Therefore, the stop members 124 act as a buffer between the extension plate 111 and the platform section 112. The stop members 124 prevent direct impact between the extension plate 111 and the platform section 112. For example, the stop members 124 prevent the entire proximal edge 112A of the platform section 112 from hitting against the proximal edge 111A of the extension plate 111 as the platform section 112 is raised from the lowered position to the raised position.

The stop members 124 may be replaced after wear and tear. For example, the stop members 124 may be replaced with new stop members 124 when the width z of the gap 126 becomes smaller than 0.50 inches (about 1.27 centimeters) because of wear and tear. The width z of the gap 126 should be approximately 0.63 inches (about 1.60 centimeters) when new stop members 124 are positioned between the platform section 112 and the extension plate 111.

The stop members 124 also limit upward movement of the lift platform 130 when the platform section 112 is in the raised position. As noted, the proximal edge 111A of the extension plate 111 is in direct contact with the first side 124A of each stop member 124 when the platform section 112 is in the raised position. The direct contact between the extension plate 111 and each stop member 124 restricts the platform section 112 from further upward movement, thereby maintaining the platform section 112 in substantial alignment with the extension plate 111. Therefore, when the platform section 112 is in the raised position, the stop members 124 prevent actuating components of the lift gate 100 (e.g., the lifting mechanism 60) from moving the platform section 112 above, and out of substantial alignment with, the extension plate 111.

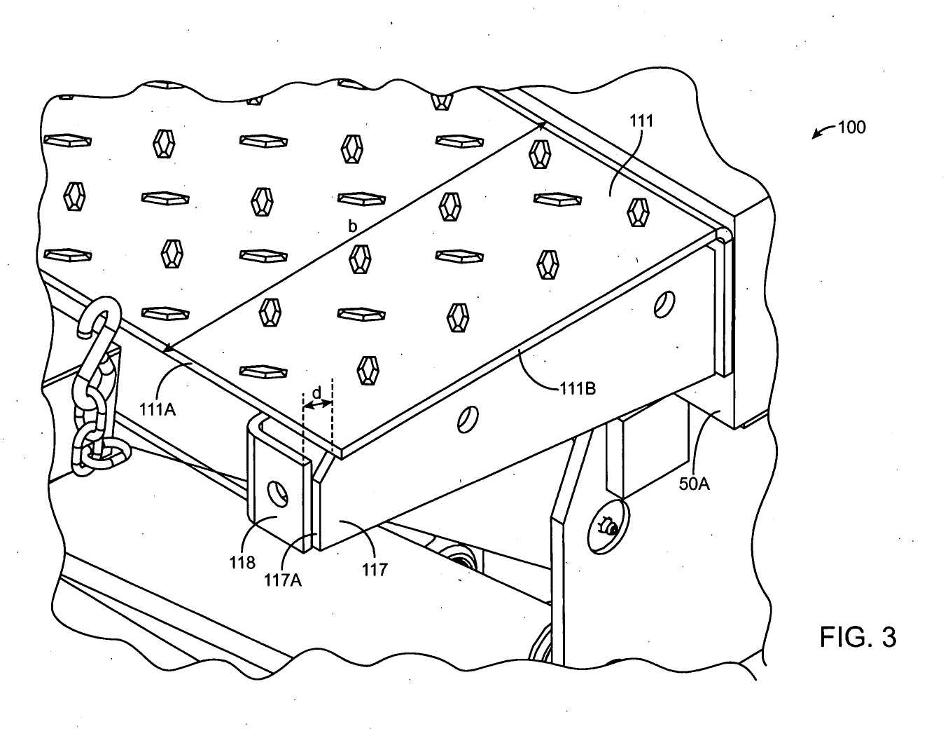

FIG. 3 illustrates a side perspective view of the extension plate 111, in accordance with an embodiment of the invention. In one example, a width of the extension plate 111, denoted as b, is between 12 inches (about 30.48 centimeters) and 12.75 inches (about 32.385 centimeters). The example numerical range provided for the width b of the extension plate 111 is an approximate numerical range only, and the present invention is not limited to an extension plate 111 with a width within this numerical range.

In one embodiment, the extension plate 111 has a pair of opposing ends 111B. Each opposing end 111B of the extension plate 111 includes a bracket 117 that extends along the underside of said opposing end 111B. Each bracket 117 has a first edge 117A that is proximate to the proximal edge 111A of the extension plate 111.

In one embodiment, each opposing end 111B of the extension plate 111 optionally further includes a protrusion member (i.e., a cap member) 118 that is disposed directly adjacent, and substantially transverse, to the first edge 117A of the bracket 117 of said opposing end 111B. Each protrusion member 118 extends (i.e., protrudes) beyond the proximal edge 111A of the extension plate 111. In the drawings, d denotes the distance by which each protrusion member 118 extends beyond the proximal edge 111A of the extension plate 111. For example, the distance d may be approximately 0.75 inches (about 1.905 centimeters). The present invention is not limited to a protrusion member 118 that extends beyond the proximal edge 111A of the extension plate 111 by the example distance provided.

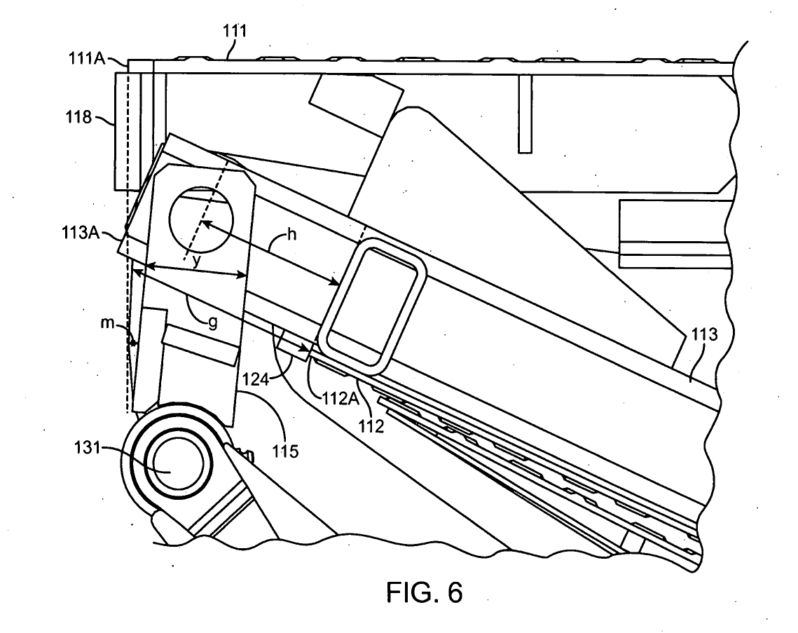

Without the protrusion members 118, one or more components of the lift gate 100, such as the lift platform 130 or the extension plate 111, may hit against a dock of a docking area when the lift gate 100 is stowed (FIG. 6) and the vehicle 70 (FIG. 1A) backs into the docking area for loading/unloading.

Therefore, the protrusion members 118 buffer the lift gate 100 against impact on a dock when the lift gate 100 is stowed underneath the vehicle 70. For example, the protrusion members 118 are the first to hit against the dock of the docking area when the vehicle 70 backs into the docking area for loading/unloading. Therefore, the protrusion members 118 protect the lift platform 130 and other components of the lift gate 100 from hitting against the dock of the docking area when the lift gate 100 is in the stowed position.

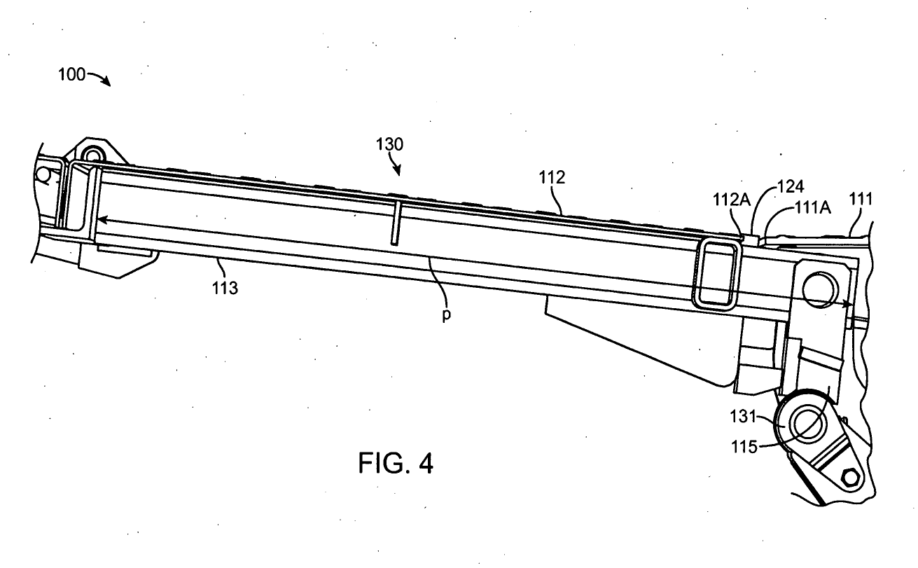

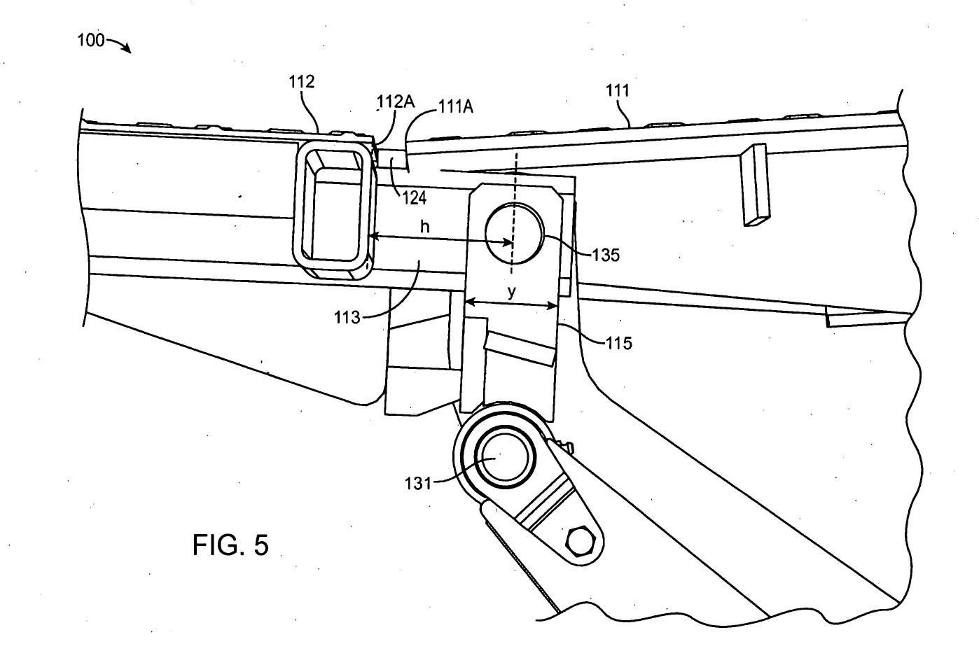

FIG. 4 illustrates a cross-sectional view of the lift gate 100, in accordance with an embodiment of the invention. The lift gate 100 further comprises shackle members 115. The shackle members 115 are connecting links that interconnect the platform section 112 with the lifting mechanism 60 (FIG. 1B). FIG. 5 illustrates an example shackle member 115, in accordance with an embodiment of the invention. The lift gate 100 further comprises support brackets 113 extending longitudinally along the underside of the platform section 112, to support the platform section 112. The support brackets 113 support the platform section 112 when the lifting mechanism 60 (FIG. 1B) raises or lowers the lift platform 130. The support brackets 113 further connect the platform section 112 to connecting links of the lift gate 100, such as shackle members 115. As shown in FIG. 4, each support bracket 113 has a length p.

In one embodiment, the distance (i.e., overhang) between the proximal edge 112A of the platform section 112 and the centre of a pivot point 135 of each shackle member 115 is denoted as h. For example, the distance h is approximately 3 inches (about 7.62 centimeters). The present invention is not limited to the example distance provided.

As shown in FIG. 5, each shackle member 115 further has a width y. For example, the width y of each shackle member 115 is approximately 2 inches (about 5.08 centimeters). In another example, the width of a wider shackle member 115 is approximately 2.5 inches (about 6.35 centimeters).

The stop members 124 may be spaced apart by positioning each stop member 124 on top of a corresponding support bracket 113.

FIG. 6 illustrates the lift gate 100 in the stowed position, in accordance with an embodiment of the invention. In case the shackle member 115 protrudes beyond the proximal edge 111A of the extension plate 111 when the lift gate 100 is stowed underneath the vehicle 70 (potentially impacting against a dock of a docking area when the vehicle 70 backs into the docking area for loading/unloading), narrowing the width of the shackle member 115 may prevent the shackle member 115 from extending beyond the proximal edge 111A of the extension plate 111 when the lift gate 100 is in the stowed position. The smaller width y provides a clearance in that prevents the shackle member 115 from hitting against the dock of the docking area when the lift gate 100 is stowed and the vehicle 70 backs into the docking area for loading/unloading.

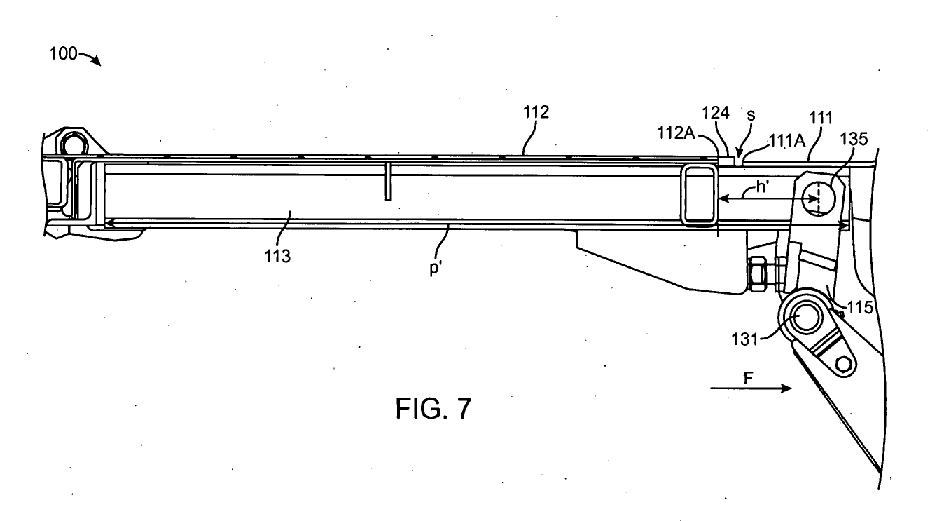

FIG. 7 illustrates a cross-sectional view of the lift gate 100, wherein the support brackets 113 of the lift gate 100 are extended, in accordance with an embodiment of the invention. In this embodiment, each support bracket 113 has a length p′ that is longer than the length p in FIG. 4. For example, the length p′ may be longer than the length p by approximately 1 inch (about 2.54 centimeters).

In another embodiment, increasing the length of each support bracket 113 to length p′ may provide the gap 126 (FIG. 2) between the extension plate 111 and the platform section 112 when the lift platform 130 is in the raised position. The gap 126 allows for stop members 124 to be positioned between the extension plate 111 and the platform section 112.

Increasing the length of each support bracket 113 to length p′ increases the distance h (FIG. 4) between the edge 112A of the platform section 112 and the centre of the pivot point 135 of each shackle member 115 to h′ (FIG. 7). The amount by which the distance between the platform section 112 and each shackle member 115, increases is relative to the amount by which the length of each support bracket 113 is increased by. For example, if the length of each support bracket 113 is increased by approximately 1 inch (about 2.54 centimeters), the distance between the platform section 112 and each shackle member 115 increases by approximately 1 inch (about 2.54 centimeters).

As such, h′ denotes the distance between the edge 112A of the platform section 112 and the centre of the pivot point 135 of each shackle Member 115 when the length of each support bracket 113 is increased to p′. For example, the distance h′ is approximately 4 inches (about 10.16 centimeters). The present invention is not limited to the example distance provided.

Increasing the length of each support bracket 113 to length p′ may provide a spacing s between the stop members 124 and the proximal edge 111A of the extension plate 111. In a lift gate installation method according to an embodiment of the invention, to minimize/reduce the spacing s during the lift gate installation/adjustment, the lift gate 100 is moved/shifted in a direction F towards the rear opening 50A of the vehicle 70 as shown in FIG. 7. The lift gate 100 is moved/shifted until the stop members 124 come in direct contact with the proximal edge 111A of the extension plate 111 when the platform section 112 is in the raised position as shown in FIG. 7.

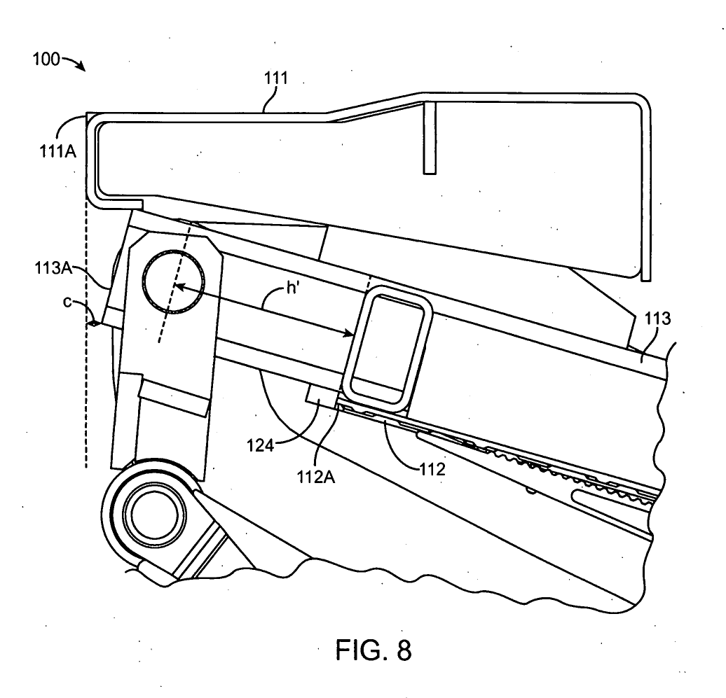

Also shown in FIG. 6, if an edge 113A of each support bracket 113 extends beyond the proximal edge 111A of the extension plate 111 when the lift gate 100 is in the stowed position, shifting the lift gate 100 towards the rear opening 50A during installation shifts each support bracket 113 under extension plate 111, such that the brackets 113 do not extend beyond the proximal edge 111A of the extension plate 111 when the lift gate 100 is in the stowed position, as shown in FIG. 8.

FIG. 8 illustrates the lift gate 100 in the stowed position, wherein the lift gate 100 is stowed further back towards the vehicle from the proximal edge 111A of the extension plate 111 than the lift gate 100 in FIG. 6, in accordance with an embodiment of the invention.

Also shown in FIG. 8, the edge 113A of each support bracket 113 does not extend (i.e., does not protrude) beyond the proximal edge 111A of the extension plate 111 when the lift gate 100 is in the stowed position. This is because moving/shifting the lift gate 100 in the direction F (FIG. 7) towards the vehicle 70 (FIG. 1A) provides a clearance c when the lift gate 100 is in the stowed position. The clearance c protects each support bracket 113 from hitting against a dock of a docking area when the vehicle 70 backs into the docking area for loading/unloading, because the extension plate 111 is the first to contact the dock (indicated by the vertical dashed line in FIG. 8).

Further, increasing the length of each support bracket 113 to p′ increases the distance between the proximal edge 112A of the platform section 112 and the centre of the pivot point 135 (FIG. 7) of each shackle member 115 to distance h′. With the increased distance h′, the proximal edge 112A of the platform section 112 is further away from the proximal edge 111A of the extension plate 111 when the lift gate 100 is in the stowed position.

The components of the lift gate 100 may be made of different kinds of metals or non-metal rigid materials. For example, stop members 124, the protrusion members 118, the brackets 117, and the extension plate 111 may be made of steel.

The present invention has been described in considerable detail with reference to certain preferred versions thereof; however, other versions are possible. Therefore, the spirit and scope of the appended claims should not be limited to the description of the preferred versions contained herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A lift gate system, comprising:
a lift platform;
a lifting mechanism for moving the lift platform between a raised position and a lowered position, wherein the lift platform is substantially aligned with an extension plate when the lift platform is in the raised position; and
at least one stop member positioned between the extension plate and the lift platform, wherein said at least one stop member provides a gap between the extension plate and the lift platform when the lift platform is in the raised position.

2. The lift gate system of claim 1, wherein:
the extension plate is coupled to a rear opening of a vehicle.

3. The lift gate system of claim 2, wherein:
said at least one stop member is directly adjacent to a proximal edge of the extension plate.

4. The lift gate system of claim 3, wherein:
said at least one stop member is directly adjacent to a proximal edge of the lift platform.

5. The lift gate system of claim 4, wherein:
said at least one stop member prevents direct impact between the extension plate and the lift platform when the lift platform is raised to the raised position.

6. The lift gate system of claim 5, wherein:
said at least one stop member restricts upward movement of the lift platform when the lift platform is in the raised position, thereby maintaining the lift platform in substantial alignment with the extension plate.

7. The lift gate system of claim 1, wherein:
each opposing end of the extension plate includes a protrusion member;
wherein each protrusion member extends beyond a proximal edge of the extension plate, such that said protrusion member protects the lift gate system against impact.

8. The lift gate system of claim 1, further comprising:
at least one shackle member that interconnects the lift platform with the lifting mechanism;
wherein a proximal edge of the extension plate extends beyond each shackle member.

9. The lift gate system of claim 1, wherein:
the lifting mechanism comprises:
at least one hydraulic pump for moving the lift platform;
a first pair of parallelogram linkages for supporting the lift platform;
a second pair of parallelogram linkages for supporting the lift platform; and
at least one pivot point on which a distal end of the lift platform is pivotably mounted for rotation.

10. A method, comprising:
positioning at least one stop member between an extension plate and a lift platform of a lift gate, wherein said at least one stop member provides a gap between the extension plate and the lift platform when the lift platform is in a raised position;
wherein the lift platform is substantially aligned with the extension plate when the lift platform is in the raised position.

11. The method of claim 10, wherein:
the lift gate further comprises a lifting mechanism for moving the lift platform between the raised position and a lowered position.

12. The method of claim 11, wherein:
the extension plate is coupled to a rear opening of a vehicle.

13. The method of claim 12, wherein:
said at least one stop member is directly adjacent to a proximal edge of the extension plate.

14. The method of claim 13, wherein:
said at least one stop member is directly adjacent to a proximal edge of the lift platform.

15. The method of claim 14, wherein:
said at least one stop member prevents direct impact between the extension plate and the lift platform when the lift platform is raised to the raised position.

16. The method of claim 15, wherein:
said at least one stop member restricts upward movement of the lift platform when the lift platform is in the raised position, thereby maintaining that the lift platform in substantial alignment with the extension plate.

17. The method of claim 10, further comprising:
positioning a protrusion member at each opposing end of the extension plate;
wherein each protrusion member extends beyond a proximal edge of the extension plate, such that said protrusion member protects the lift gate against impact.

18. The method of claim 11, further comprising:
interconnecting the lift platform with the lifting mechanism via at least one shackle member;
wherein a proximal edge of the extension plate extends beyond each shackle member.

19. The method of claim 11, wherein:
the lifting mechanism comprises:
at least one hydraulic pump for moving the lift platform;
a first pair of parallelogram linkages for supporting the lift platform;
a second pair of parallelogram linkages for supporting the lift platform; and
at least one pivot point on which a distal end of the lift platform is pivotably mounted for rotation.

20. A method, comprising:
providing a gap between an extension plate and a lift platform of a lift gate when the lift platform is in a raised position;
positioning at least one stop member in the gap, wherein said at least one stop member is positioned between the lift platform and the extension plate when the lift platform is in the raised position; and
pushing forward the lift gate until said at least one stop member is directly adjacent to both the extension plate and the lift platform;
wherein the lift platform is substantially aligned with the extension plate when the lift platform is in the raised position.

21. The method of claim 20, wherein:
the lift gate further comprises:
a lifting mechanism for moving the lift platform between the raised position and a lowered position; and
one or more support brackets that support the lift platform when the lifting mechanism raises or lowers the lift platform.

22. The method of claim 21, wherein:
each support bracket has a length; and
providing the gap between the extension plate and the lift platform when the lift platform is in the raised position comprises extending the length of each support bracket.

23. The method of claim 22, wherein:
the extension plate is coupled to a rear opening of a vehicle.

24. The method of claim 23, wherein:
pushing forward the lift gate until said at least one stop member is directly adjacent to both the extension plate and the lift platform comprises pushing forward the lift gate towards the front of the vehicle.

25. The method of claim 24, wherein:
the lift gate is stowed further back in relation to the extension plate when the lift gate is pushed forward towards the front of the vehicle.

26. The method of claim 25, wherein:
said at least one stop member prevents direct impact between the extension plate and the lift platform when the lift platform is raised to the raised position.

27. The method of claim 26, wherein:
said at least one stop member restricts upward movement of the lift platform when the lift platform is in the raised position, thereby maintaining that the lift platform in substantial alignment with the extension plate.

28. The method of claim 20, further comprising:
positioning a protrusion member at each opposing end of the extension plate;
wherein each protrusion member extends beyond a proximal edge of the extension plate, such that said protrusion member protects the lift gate against impact.

29. The method of claim 21, further comprising:
interconnecting the lift platform with the lifting mechanism via at least one shackle member;
wherein a proximal edge of the extension plate extends beyond each shackle member.

30. The method of claim 21, wherein:
the lifting mechanism comprises:
at least one hydraulic pump for moving the lift platform;
a first pair of parallelogram linkages for supporting the lift platform;
a second pair of parallelogram linkages for supporting the lift platform; and
at least one pivot point which a distal end of the lift platform is pivotably mounted for rotation.
